(19) United States
(12) Patent Application Publication
(10) Pub. No.: US 2020/0111039 A1
(43) Pub. Date: Apr. 9, 2020

(54) CALCULATING CONSEQUENCE OF FAILURE

(71) Applicant: Fracta, Redwood City, CA (US)

(72) Inventors: Daichi Yoshikawa, Cupertino, CA (US); Yongyang Wang, San Mateo, CA (US); Matti Salomon Kakkori, Carlsbad, CA (US); Joel Michael Weingarten, Pleasanton, CA (US)

(73) Assignee: Fracta, Redwood City, CA (US)

(21) Appl. No.: 16/597,691

(22) Filed: Oct. 9, 2019

Related U.S. Application Data
(63) Continuation-in-part of application No. 16/365,466, filed on Mar. 26, 2019.
Application No. 16/365,466 is a continuation-in-part of application No. 16/365,522, filed on Mar. 26, 2019.
Application No. 16/365,522 is a continuation-in-part of application No. PCT/US19/24139, filed on Mar. 26, 2019.
Application No. PCT/US19/24139 is a continuation-in-part of application No. PCT/US19/24141, filed on Mar. 26, 2019.
(60) Provisional application No. 62/858,266, filed on Jun. 6, 2019.
(60) Provisional application No. 62/743,477, filed on Oct. 9, 2018.
(60) Provisional application No. 62/743,483, filed on Oct. 9, 2018.
(60) Provisional application No. 62/743,485, filed on Oct. 9, 2018.

(51) Int. Cl. G06Q 10/06; G06Q 10/00; G06Q 50/06

(52) U.S. Cl. CPC G06Q 10/0635; F16L 55/00; G06Q 50/06; G06Q 10/20

(57) ABSTRACT

Systems and methods calculate consequence of failure values for pipe segments in a network. The calculation can be based on an estimated repair cost, a monetary value associated with the loss of service to customers and also a monetary value associated with the interruption of transportation such as traffic interruption. The calculation can also take into account a pipe segments proximity to a critical facility.

### REFERENCE TO RELATED APPLICATIONS

This application is a continuation-in-part of each of:
U.S. patent application Ser. No. 16/365,466 filed on Mar. 26, 2019;
U.S. patent application Ser. No. 16/365,522 filed on Mar. 26, 2019;
Intl Pat. Appl. No. PCT/US19/24139 filed on Mar. 26, 2019; and
Intl Pat. Appl. No. PCT/US19/24141 filed on Mar. 26, 2019.

This application incorporates by reference and claims the benefit of the filing date of each of the above-identified four patent applications, as well as of the applications that they incorporate by reference, directly or indirectly, and the benefit of which they claim, including U.S. provisional applications, U.S. non-provisional applications, and International applications.

This patent application claims the benefit of and incorporates by reference each of the following provisional applications:
U.S. Prov. Ser. No. 62/743,477 filed Oct. 9, 2018;
U.S. Prov. Ser. No. 62/743,483 filed Oct. 9, 2018;
U.S. Prov. Ser. No. 62/743,485 filed Oct. 9, 2018; and
U.S. Prov. Ser. No. 62/858,266 filed Jun. 6, 2019.

This patent application is related to and incorporates by reference the following U.S. Non Provisional, International Patent Applications and U.S. Provisional patent applications:
U.S. Prov. Ser. No. 62/649,058 filed Mar. 28, 2018;
U.S. Prov. Ser. No. 62/658,189 filed Apr. 16, 2018;
U.S. Prov. Ser. No. 62/671,601 filed May 15, 2018;
U.S. Pat. Appl. Ser. No. ______ filed on Oct. 9, 2019 (Attorney Docket No. Fracta-008-US);
Intl Pat. Appl. No. PCT/US19/______ filed on Oct. 9, 2019 (Attorney Docket No. Fracta-008-PCT); and
Intl Pat. Appl. No. PCT/US19/______ filed on Oct. 9, 2019 (Attorney Docket No. Fracta-009-PCT).
All of the above-referenced provisional and non-provisional patent applications are collectively referenced herein as “the commonly assigned incorporated applications.”

### FIELD

This patent specification generally relates to automated systems and automated methods for managing networks of interconnected assets such as pipeline networks. More particularly this specification relates to automated systems and automated methods for calculating consequence of failure for pipeline networks, such as drinking water supply networks.

### BACKGROUND

More than one million miles of water pipe in the United States alone are reaching the end of their useful life and are in need of replacement. Over the next 25 years, at least one trillion dollars will need to be invested in order to maintain the current level of service for a growing population. Ignoring the problem will lead to higher repair costs and increased service disruptions.

In the United States, the approximately 50,000 water utility companies do not have the resources to replace them all, due to limited budgets. Since all expired pipe cannot be replaced, it is vital that replacing pipes in the worst condition be prioritized while strategically leaving expired but healthy pipe to be replaced in the future.

The replacement plans that utility companies have created are fairly inaccurate and in many cases are not useful. The simplistic models that utility companies have created have led to the wasteful replacement of pipe that still would have had more years of life. Over the next twenty-five years, this would lead to millions of dollars of wasteful spending.

In coming up with planned projects or jobs for replacing various segments of pipe, a utility company may want to rely on the consequence of the pipe segment failing. However, calculating the consequence of failure can be quite complex. Beyond the direct cost of repair of the pipe, there are many other types of indirect costs such as the consequence of customers' water service being interrupted, and impacts on nearby “critical” facilities such as hospitals. Efforts are made to incorporate such indirect costs by employing “weighting” mechanisms for each type of additional factor. However, such efforts can create an imbalanced view of the total risk profile of the system.

### SUMMARY

According to some embodiments, a method is described for calculating consequence of failure values for a network of interconnected managed assets. The method includes: calculating with the computer processing system a cost of service interruption value associated with each of the plurality of the interconnected managed assets; calculating with the computer processing system a cost of transportation interruption associated with each of the plurality of the interconnected managed assets; and calculating with the computer processing system an aggregate consequence of failure value for each of the plurality of the interconnected managed assets based at least in part on an expected cost of repair of the manage asset, the calculated cost of service interruption value, and calculated cost of transportation interruption value.

According to some embodiments, the aggregate consequence of failure value, the cost of repair, the cost of service interruption value, and the cost of transportation interruption value are expressed as monetary values and the aggregate consequence of failure value includes a sum of the cost of repair, the cost of service interruption value, and the cost of transportation interruption value.

According to some embodiments, the calculating of the cost of service interruption, and the cost of transportation interruption values includes calculating a product of expected time for making repair to the managed asset and a predicted cost per unit of time due to the respective interruption. The predicted cost per unit of time due to a service interruption can be based on a per capita cost of service interruption and a predicted number of people who will experience a service interruption due to failure of the managed asset. The predicted cost per unit of time due to a transportation interruption can be based on a per capita cost of transportation interruption and a predicted number of people who will experience transportation interruption due to failure of the managed asset.

According to some embodiments, when a managed asset is in close proximity to a critical facility, the aggregate consequence of failure value can also be based on costs associated with the service interruption and/or traffic interruption for the critical facility.

According to some embodiments, the interconnected managed assets are pipe segments. The pipe segments can be used for carrying water to consumers. According to some other embodiments, the pipe segments can be used for carrying: fresh water; waste water; recycled water; brackish water; storm water; sea water; drinking water; steam; compressed air; oil; and natural gas.

According to some embodiments, the method can also include: displaying on a graphical user interface a plurality of parameters relating to the calculating of the consequence of failure values; and receiving selections of or modifications to one or more of the plurality of parameters from the user.

According to some embodiments, a system is described for calculating consequence of failure values for a network of interconnected managed assets. The system includes: a database that stores an expected cost of repair for each of a plurality of the managed assets; and a processing system configured to calculate a cost of service interruption value associated with each of the plurality of managed assets, calculate a cost of transportation interruption associated with each of the plurality of the interconnected managed assets, and calculate an aggregate consequence of failure value for each of the plurality of managed assets based at least in part on the expected cost of repair, the calculated cost of service interruption value, and calculated cost of transportation interruption value for the managed asset.

As used herein, the grammatical conjunctions “and”, “or” and “and/or” are all intended to indicate that one or more of the cases, object or subjects they connect may occur or be present. In this way, as used herein the term “or” in all cases indicates an “inclusive or” meaning rather than an “exclusive or” meaning.

### BRIEF DESCRIPTION OF THE DRAWINGS

To further clarify the above and other advantages and features of the subject matter of this patent specification, specific examples of embodiments thereof are illustrated in the appended drawings. It should be appreciated that elements or components illustrated in one figure can be used in place of comparable or similar elements or components illustrated in another, and that these drawings depict only illustrative embodiments and are therefore not to be considered limiting of the scope of this patent specification or the appended claims. The subject matter hereof will be described and explained with additional specificity and detail through the use of the accompanying drawings in which:

FIGS. 1A-1C are examples of a graphical user interface for a general overview of basic COF factors, according to some embodiments;

FIG. 2 is an example of a graphical user interface for configuring parameters relating to critical facilities, according to some embodiments;

FIG. 3 is an example of a graphical user interface for configuring parameters relating to other damages, according to some embodiments;

FIG. 4 is an example of a map graphical user interface for a consequence of failure module, according to some embodiments; and

FIGS. 5, 6A and 6B are examples of a graphical user interface showing report views for a consequence of failure module, according to some embodiments.

### DETAILED DESCRIPTION

A detailed description of examples of preferred embodiments is provided below. While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

According to some embodiments, a consequence of failure (COF) module allows utility companies to efficiently create consequence of failure information and visualize the information's impact in a map or report format. The consequence of failure module takes into consideration: user input; prepared environmental information; and infrastructure information. According to some embodiments, the COF module generates a dollar value consequence that does not rely on assignment of weighting factors or making complicated layered decisions on relative importance of various factors. A subjective and clear view of the true COF impact can therefore be provided to utilities based on simple straight forward configuration.

According to some embodiments, the COF module can be described in three major groups of functions: analysis; view map; and reports.

Module 1—Analysis. This module takes the user through the consequence analysis by allowing user to configure three basic groups of COF factors (basic COF factor, critical facility, other damage). In addition, the module provides a structure to allow user to establish separate scenarios so that they can choose different values to be used in order to determine which COF configuration works best for them.

Module 2—View Map. The user can inspect both the results of likelihood of failure and consequence of failure information on COF map, as well as environmental factors that contributes to the COF analysis. These factors include transportation infrastructure, critical facilities, and others that relates to COF.

Module 3—Reports. Reports provide a clear evaluation on user's utilities consequence of failure profile by allowing user to select categories and level of impact by their own standards. Also, user can inspect the distribution of consequence of failure by pipe asset information (size, material) or by types of consequences in charts.

The following sections provide detailed description of functions offered in each stage within the COF module.

Module 1—Analysis.

The analysis module includes three main groups of setup: COF Scenario, COF Cost Factors and Run Analysis.

Setup COF Scenario. Prior to going into details about COF configuration, the user should to define a new scenario or existing scenario to be modified through the analysis page. The user will choose a name and description of the scenario in mind, then start by setting a brand new COF from scratch with blank configuration page, copying a scenario from existing ones, or uploading COF values from the customer's own database (i.e. skipping the COF analysis by uploading customer's own COF analysis.

Modify and update COF factors. The configuration of COF factors for a blank scenario will now be described.

Basic COF Factors.

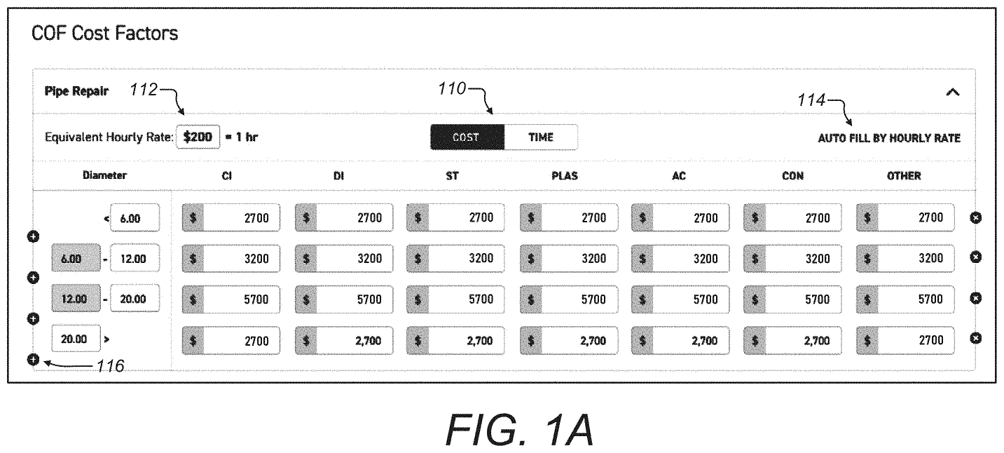

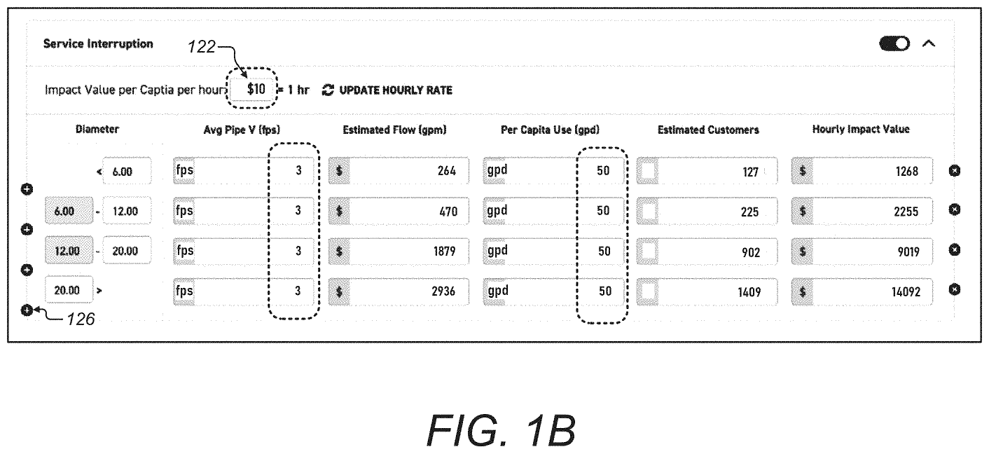

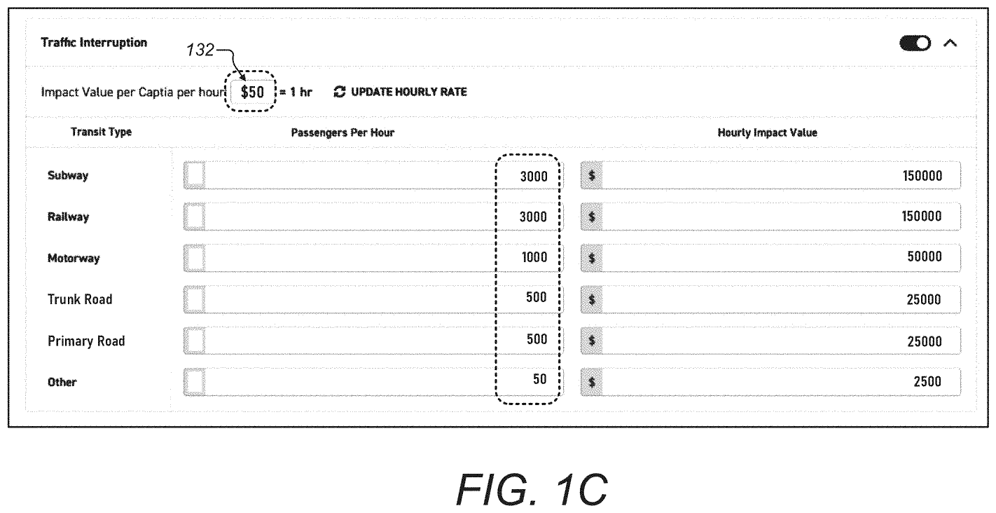

FIGS. 1A-1C are examples of a graphical user interface for a general overview of basic COF factors, according to some embodiments. In particular FIG. 1A shows the interface displaying parameters for pipe repair costs, FIG. 1B shows the interface displaying parameters for service interruption costs, and FIG. 1C shows the interface displaying parameters for traffic interruption. The starting numbers included in input table shown in FIGS. 1A-1C are “dummy” numbers.

Pipe Repair. This section of the basic COF factor includes two parts: cost and time. The customer may populate either one of the two parts as a starting point by clicking on button 110. The customer's selection will often depend on the record keeping method chosen by utility company. The other part (cost or time) will then be automatically populated using a preassigned equivalent hourly rate entered in field 112.

For example, the customer may decide to fill in the cost table based on the information as shown in Table 1.

TABLE 1

| | Construction Cost | | | | | | |
|---|---|---|---|---|---|---|---|
| Pipe Sizes | CI | DI | ST | PLAS | AC | CON | OTHER |
| <6 | 2700 | 2700 | 2700 | 2700 | 2700 | 2700 | 2700 |
| 6-12 | 3200 | 3200 | 3200 | 3200 | 3200 | 3200 | 3200 |
| 12-20 | 5700 | 5700 | 5700 | 5700 | 5700 | 5700 | 5700 |
| >20 | 2700 | 2700 | 2700 | 2700 | 2700 | 2700 | 2700 |

The user can then define an equivalent hourly rate (in field 112) and reasonably translate the cost of construction to the duration of construction, based on labor rate, equipment cost and others. The more resources (labor and equipment) that are used for the same construction cost, the less time there is for the actual repair. In this way, the user can decide where this hourly rate conversion is deemed appropriate for their utility/agency.

Assuming that the user selects $200/hr as the hourly rate value, then when the “time” table is selected in area 110, user can automatically populate the table by clicking “autofill by hourly rate” button 114, which results in the Table 2.

TABLE 2

| | Construction Duration | | | | | | |
|---|---|---|---|---|---|---|---|
| Pipe Sizes | CI | DI | ST | PLAS | AC | CON | OTHER |
| <6 | 4 | 4 | 4 | 4 | 4 | 4 | 4 |
| 6-12 | 4 | 4 | 4 | 4 | 4 | 4 | 4 |
| 12-20 | 8 | 8 | 8 | 8 | 8 | 8 | 8 |
| >20 | 16 | 16 | 16 | 16 | 16 | 16 | 16 |

By clicking the plus and minus sign buttons 116 on the sides of the tables, user can add or remove rows to change the increment steps or resolution of pipe sizes that are shown for both tables. The increment steps are linked and mirrored between these two tables.

While the construction cost table provides a clear dollar value for the consequence from pipe repair, the time duration of the repair will be directly related to the dollar value of consequence associated with the following two factors: service interruption, and traffic Interruption.

Once the autofill is complete for both “cost” and “time” tables, the user is able to fine tune each table by modifying the values within each cell without triggering another autofill action (unless the autofill button 114 is clicked). This allows the user to “break” the linkage of the two tables through the equivalent hourly rate, and create two independent tables of time and cost of repair based on his/her best engineering judgement.

After the two independent tables of cost and time of repair are in place, user can still click the autofill button 114 in either table to relink the information between the two tables, if desired.

Service Interruption. Service Interruption “cost” can be defined as the dollar value representing the customer's loss of water supply. In the described COF module, the user can define cost values for service interruption based on various factors including: (1) the number of individuals impacted; (2) the amount of time they are impacted; and (3) an hourly dollar value assigned to the impact.

In FIG. 1B, the hourly value can be entered in field 122. The dollar amount entered defines the amount that the utility company or agency would spend to prevent a single customer from losing service for 1 hour of time. It has been found that this metric provides a uniform measure for multiple scenarios (number of customers losing service for a given duration).

The duration of impact, as described supra, can be determined by the size and material of the pipe, which relates to the construction cost of the pipe. This information therefore comes from the pipe repair table (shown in FIG. 1A and Tables 1 and 2).

The number of individuals impacted is estimated from the size of pipe. By clicking the plus/minus sign buttons 126 on the sides of the table, user can add or remove rows to change the increment steps or resolution of pipe sizes that are shown. The cells that the user should input are highlighted with dotted lines.

User can define the average pipe velocity so that it can be used to multiply with the pipe's cross-sectional area to get the average flow within a range of pipe sizes. Typical range of velocity is from 3-5 feet per second (fps) and can be obtained from hydraulic model results or more generic knowledge based on design specification.

The daily per capita water usage is either available from city's planning document or operator's knowledge, a typically value is 50 gallons per day per person. With the average daily flow and average daily water use per person, the the estimated number of customers can be automatically calculated and as can an hourly value impact based on the other two factors as shown in the equation below:

Total Service Interruption Impact=Number of Customers Impacted×Hourly Value per Customer×Time of Repair

Traffic Interruption. Traffic Interruption can be defined as a dollar value representing individuals having access to sections of a transportation infrastructure. In the described COF module, the user can define value for traffic interruption based on”: (1) the number of individuals impacted; (2) a length of time they are impacted; and (3) the hourly value assigned to this impact.

In FIG. 10, the user can input an hourly rate value in field 132. The dollar amount entered defines the amount that the utility company or agency would spend to prevent a single customer from being delayed in transit for 1 hour of time. It has been found that this metric provides a uniform measure for multiple scenarios (number of customers being delayed or stopped in transit for a given duration).

The time of impact, as described supra, can determined by the size and material of the pipe, which relates to the construction cost of the pipe. This information therefore comes from the pipe repair table (shown in FIG. 1A and Tables 1 and 2).

The number of individuals impacted is estimated from the type of transit. The general process is illustrated in FIG. 10. The cells that the user should input are highlighted with dotted lines.

The user can provide an estimation on number of passengers per hour for each type of transit types. This information can be either based on common knowledge or information provided by public information from agencies in charge (e.g. Caltrans, BART, or transportation bureau). Similar to service interruption, an hourly value per passenger is assigned universally to all transit types. The dollar value assigned to each pipe can be calculated in the equation below.

Total Traffic Interruption Impact=Number of Passengers Impacted×Hourly Value per Passenger×Time of Repair

Critical Facilities.

According to some embodiments, “critical facilities” can be defined according to a governmental agency such as FEMA (Federal Emergency Management Agency) in the United States. The operation and access to and from these facilities is highly important to maintain basic public services.

In the context of water utilities, any potential failure of water mains that can have an impact on critical facilities should be paid attention to. Traditionally that has been done through various weighting mechanisms that either results in over emphasis or under value of the importance of these facilities over the likelihood of failure. The conventional “weighting” mechanism approach has been found to create an imbalanced view of the total risk profile of the system.

According to some embodiments, the described COF module considers the essential function of these critical facilities and elevates its importance by assigning a value that is representative of the importance of these facilities, while at the same time making sure that they are comparable to other factors and parameters. In order to achieve this, if a critical facility relies on both water service and traffic access during an emergency, the user should overwrite those values with a higher threshold number that is appropriate for their agency, regardless of the actual pipe size or transit type, which may be less significant compared to other nearby pipes or transit. In other words, even if the pipes are small, or the mode of transit is a local road, the user has the opportunity to simply increase their value as if the pipes are larger and the transit type is closer to mass transit.

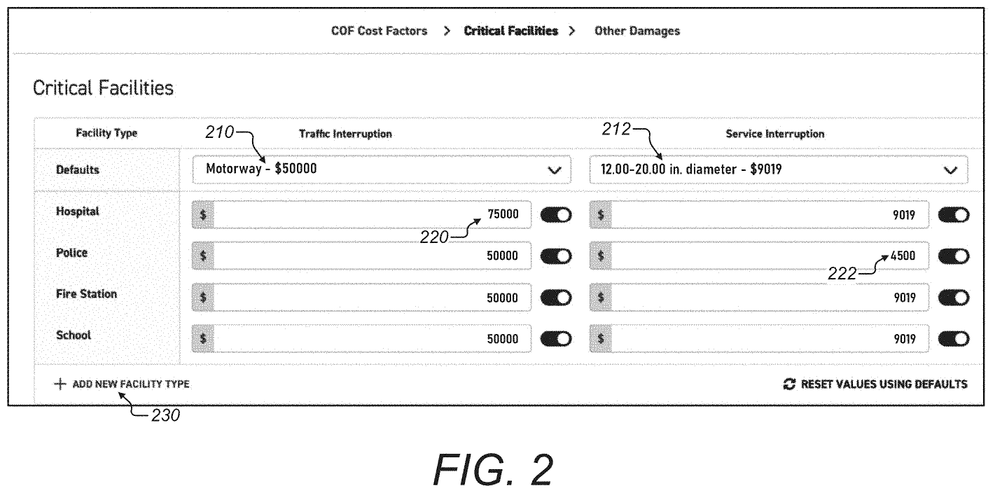

FIG. 2 is an example of a graphical user interface for configuring parameters relating to critical facilities, according to some embodiments. First, the user should define the default value of traffic and service interruption value based on the values created by the Basic COF Factors input as shown in FIGS. 1B and 10. In FIG. 2, the user can select from the drop down fields 210 and 212 hourly values from the traffic and service interruption rates, respectively. In the example shown, the user has selected values of $50000 for a motorway, $9019 for 12-20 inch pipes. These values will be used as default hourly values to be applied to overwrite the traffic and service interruption value based on actual transit type and pipe size for nearby the critical facilities.

The COF engine will then look for appropriate critical facilities where both access and water supply are important. As a default, both access and water supply are considered important for all types of facilities. However, user may choose to switch one or both of the aspects off as appropriate (i.e. water supply may be less important for police stations).

The COF module automatically assigns the higher value from the default larger pipe and mass transit impact value to pipelines that are close to these facilities. The traffic and service interruption values are overwritten by these higher values reflecting the importance of maintaining access and/or water supply to these places.

Using button 230, the user has the ability to add additional types of facilities by picking from existing GIS information from the COF system, or upload custom GIS information to represent facilities that are important to them. For example, these facilities can include but are not limited to: pumping facilities, treatment facilities, key customers, large industrial users, and etc.

The user also has means to manually modify the overwrite value after turning on either traffic or service interruption for each type of facility. While default value will be assigned based on the customer's initial choice of transit type or pipe sizes, they may be fine-tuned if the customer determines that the facility is more important or less important compared to other types of facility or the default value provided through pipe sizes and transit types. In the example shown in FIG. 2, the user has overwritten the traffic interruption value for hospitals (220) and the service interruption value for police facilities (222). The manually changed values can be restored to default by clicking the reset button, if the interruption type is active (turned on).

Other Damages.

In general, other damages are infrequent events that are not expected every time the asset fails. In other words, it is expected that at least some of the time the “other damage” will not occur even though the associated pipe segment fails. In some examples, some of the “other damages” may happen 10% of the time when the pipe segment breaks (e.g. near a restaurant and breakage causes business interruption). In general are not expected to occur every time the associated pipe segment fails. These are incidences that do not happen frequently, and are not associated with facilities that are critical to emergency response or water supply. Other examples of these damages include building damage, fish kills (environmental impact) or personal injury.

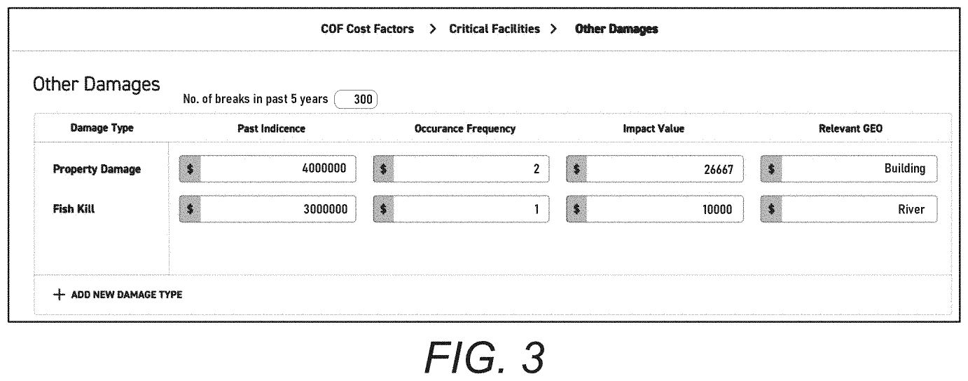

FIG. 3 is an example of a graphical user interface for configuring parameters relating to other damages, according to some embodiments. These incidents can be grouped into two major categories: (1) incidents associated with proximity to a GIS feature type (building, river, lake), such as building damage; and (2) incidents that are independent from any GIS feature type, such as injuries or fish kills.

For other damage types that can be related to a GIS feature type, the user can input either the estimated impact value from a past incidence or from projected risk of a future incidence, along with number of times it happened in the past time (if planning horizon is 5 years, or 5 year LOF, the look back needs to be at least 5 years for past incidence). If the incidence never happened in the past and the user would like to add projection for future, occurrence frequency could be set as 1.

The described COF system will extract the number of breaks happened from the past 5 years (in this example there were 300) and use that information to calculate the likelihood that such incidence would occur in user's system by dividing the number of past occurrence with the number of total breaks in the look back period. The representative impact value is then calculated by multiplying the value of the incident with its actual likelihood of occurring during the period.

The described COF system then looks for the relevant GIS feature to this type of damage, that doesn't occur every time a pipe breaks, but damaging enough to have an overall impact. For building damage, any pipes that are close to a building will be assigned an impact value that's equal to:

Impact Value=Past Incident Value×Number of Past Occurrence/Number of Past Total Breaks in Planning Period.

For other damage types that are independent from, or cannot be clearly related to any GIS feature types, user input for the GIS feature (“Relevant GEO” in FIG. 3) is not needed.

Run COF Analysis.

After configuration of the COF parameters, the user can either run COF analysis itself, or also calculate BRE (Business Risk Exposure) values by multiplying the resulting COF values with default LOF value (typically 5 year LOF).

Module 2—Map.

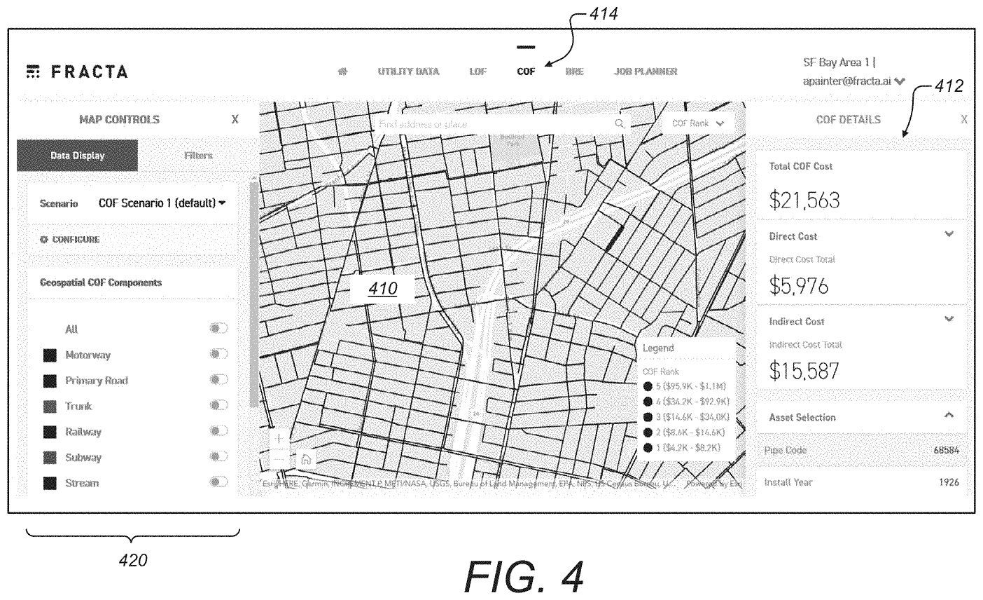

FIG. 4 is an example of a map graphical user interface for a consequence of failure module, according to some embodiments. The user can do the following on the map: (1) inspect pipe COF heatmap 410 and individual pipe segments to visualize where the consequence of failure value are highest; (2) inspect pipe COF details (section 412) of the different categories that make up the COF value, including basic COF factors, critical facility and other damages, as well as their sub categories; (3) inspect pipe segment information, including length, material, installation year and etc.; and (4) on the map view, change layers of display between pipe information (diameter, material, install year), LOF information, COF information and BRE information (menu bar 414). Legends will change in response to the user's selection; and (5) on map control (section 420), pick the scenarios in view, select varies GIS features that's relevant to COF calculation and analysis to be shown on the map.

Module 3—Report.

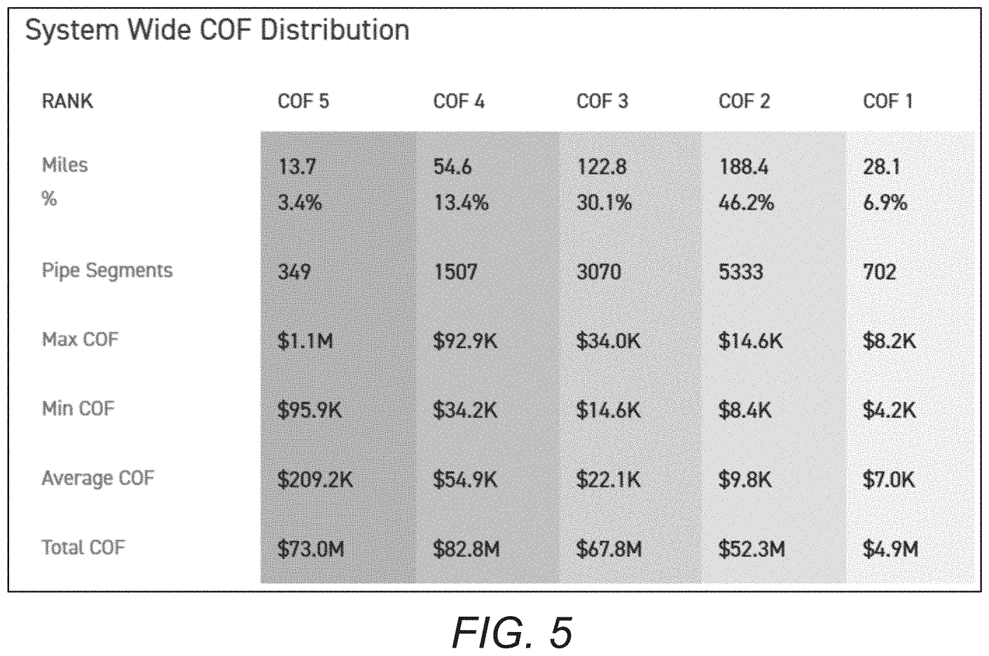

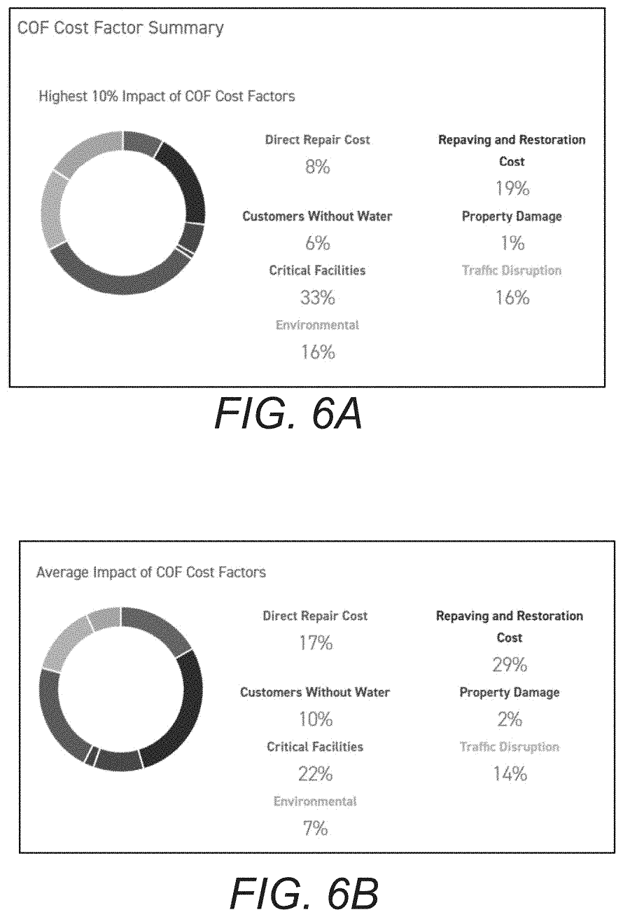

FIGS. 5, 6A and 6B are examples of a graphical user interface showing report views for a consequence of failure module, according to some embodiments. In the report views, the user will be able to select the COF module generated charts and tables to identify, compare and contrast the following aspects of system COF in the reports section: (1) distribution of the dollar amount risk value from different categories of consequence of failure across pipe material and size; (2) distribution, summary of the value of consequence of failure across different categories of COF; and (3) distribution of Business Risk Exposure similar to the above.

According to some embodiments the described COF module can be applied to assets other than drinking water supply, such as pipes for carrying other fluid, such as waste water, recycled water, brackish water, storm water, sea water, steam, compressed air, oil and natural gas. According to some embodiments, the described systems and methods can be applied to networks of fiber cables, electrical wires, as well as to utility poles.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What it claimed is:

1. A method for calculating consequence of failure values for a network of interconnected managed assets, the method comprising:
calculating with the computer processing system a cost of service interruption value associated with each of the plurality of the interconnected managed assets;
calculating with the computer processing system a cost of transportation interruption associated with each of the plurality of the interconnected managed assets; and
calculating with the computer processing system an aggregate consequence of failure value for each of the plurality of the interconnected managed assets based at least in part on an expected cost of repair of the manage asset, the calculated cost of service interruption value, and calculated cost of transportation interruption value.

2. A method according to claim 1 wherein the aggregate consequence of failure value, the cost of repair, the cost of service interruption value, and the cost of transportation interruption value are expressed as monetary values and the aggregate consequence of failure value includes a sum of the cost of repair, the cost of service interruption value, and the cost of transportation interruption value.

3. A method according to claim 2 wherein said calculating of the cost of service interruption, and the cost of transportation interruption values includes calculating a product of expected time for making repair to the managed asset and a predicted cost per unit of time due to the respective interruption.

4. A method according to claim 3 wherein the predicted cost per unit of time due to a service interruption is based at least in part on a per capita cost of service interruption and a predicted number of people who will experience a service interruption due to failure of the managed asset.

5. A method according to claim 4 wherein said interconnected managed assets are pipe segments and the predicted number of people who will experience a service interruption is based at least in part on the diameter of the pipe segment.

6. A method according to claim 3 wherein the predicted cost per unit of time due to a transportation interruption is based at least in part on a per capita cost of transportation interruption and a predicted number of people who will experience transportation interruption due to failure of the managed asset.

7. A method according to claim 1 wherein when a managed asset is in close proximity to a critical facility, said calculating of the aggregate consequence of failure is further based in part on costs associated with the service interruption and/or traffic interruption for the critical facility.

8. A method according to claim 1 wherein the calculating of the aggregate consequence of failure at least some of the managed assets is further based in part on an expected cost value for infrequent events that are expected to occur at a rate of less than one hundred percent of the time for each of the manage assets.

9. A method according to claim 8 wherein the infrequent events are expected to occur at a rate of less than ten percent of the time for each of the manage assets.

10. A method according to claim 1 wherein said interconnected managed assets are pipe segments.

11. A method according to claim 10 wherein said pipe segments form a network for carrying water to consumers.

12. A method according to claim 10 wherein said pipe segments are configured to carry fluid of a type selected from a group consisting of: fresh water; waste water; recycled water; brackish water; storm water; sea water; drinking water; steam; compressed air; oil; and natural gas.

13. A method according to claim 1 further comprising:
displaying on a graphical user interface a plurality of parameters relating to the calculating of the consequence of failure values; and
receiving selections of or modifications to one or more of said plurality of parameters from said user.

14. A system for calculating consequence of failure values for a network of interconnected managed assets, the system comprising:
a database that stores an expected cost of repair for each of a plurality of the managed assets; and
a processing system configured to calculate a cost of service interruption value associated with each of the plurality of managed assets, calculate a cost of transportation interruption associated with each of the plurality of the interconnected managed assets, and calculate an aggregate consequence of failure value for each of the plurality of managed assets based at least in part on the expected cost of repair, the calculated cost of service interruption value, and calculated cost of transportation interruption value for the managed asset.

15. A system according to claim 14 wherein the aggregate consequence of failure value, the cost of repair, the cost of service interruption value, and the cost of transportation interruption value are expressed as monetary values and the aggregate consequence of failure value includes a sum of the cost of repair, the cost of service interruption value, and the cost of transportation interruption value.

16. A system according to claim 15 wherein said calculating of the cost of service interruption, and the cost of transportation interruption values includes calculating a product of expected time for making repair to the managed asset and a predicted cost per unit of time due to the interruption.

17. A system according to claim 16 wherein the predicted cost per unit of time due to a service interruption is based at least in part on a per capita cost of service interruption and a predicted number of people who will experience a service interruption due to failure of the managed asset.

18. A system according to claim 16 wherein the predicted cost per unit of time due to a transportation interruption is based at least in part on a per capita cost of transportation interruption and a predicted number of people who will experience transportation interruption due to failure of the managed asset.

19. A system according to claim 14 wherein said interconnected managed assets are linear pipe segments forming a network for carrying water to consumers and said potential improvement projects are potential pipe replacement projects.

20. A system according to claim 14 wherein said interconnected managed assets are pipe segments configured to carry fluid of a type selected from a group consisting of: fresh water; waste water; recycled water; brackish water; storm water; sea water; drinking water; steam; compressed air; oil; and natural gas.
